(19) United States
(12) Patent Application Publication
(10) Pub. No.: US 2020/0399823 A1
(43) Pub. Date: Dec. 24, 2020

(54) METHOD OF MANUFACTURING ANTI-SOILING CARPET, AND ANTI-SOILING CARPET

(71) Applicants: NICCA CHEMICAL CO., LTD., Fukui-shi (JP); NICCA U.S.A., INC., Fountain Inn, SC (US)

(72) Inventors: Yumiko URUSHISAKI, Fukui-shi (JP); Yoshiki TSUGE, Fukui-shi (JP); Tony BRANDON, Fountain Inn, SC (US); Magali BROWN, Fountain Inn, SC (US); Atsushi YONEMOTO, Fountain Inn, SC (US)

(21) Appl. No.: 16/444,498

(22) Filed: Jun. 18, 2019

(51) Int. Cl. D06M 15/263; D06M 15/248; D06M 15/507; C08F 214/06; C08F 214/08; C08F 220/18

(52) U.S. Cl. CPC D06M 15/263; D06M 15/248; D06M 15/507; D06M 2200/01; C08F 214/08; C08F 220/18; C08F 214/06

(57) ABSTRACT

A method of manufacturing an anti-soiling carpet comprises a step of treating a carpet with a liquid solution containing an anti-soiling agent, the anti-soiling agent containing a non-fluorinated polymer (α) and a non-fluorinated polymer (ii), the non-fluorinated polymer (α) containing a constituent unit derived from a monomer represented by formula (A-1) with a specified ratio and another constituent unit derived from a specified (meth)acrylate ester monomer, the non-fluorinated polymer (β) containing a constituent unit derived from at least one monomer of methyl methacrylate and ethyl methacrylate with a specified ratio and a another constituent unit derived from another specified (meth)acrylate ester monomer:

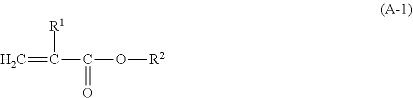

wherein R¹ represents a hydrogen atom or a methyl group, and R² represents a monovalent hydrocarbon group having 12 to 30 carbon atoms, optionally having a substituent.

### TECHNICAL FIELD

The present invention relates to an anti-soiling carpet and a method of manufacturing the anti-soiling carpet, and more specifically an anti-soiling carpet with anti-soiling properties imparted by a non-fluorinated anti-soiling agent.

### BACKGROUND

An anti-soiling-processed anti-soiling carpet is used in various places such as houses, hotels, offices and restaurants. In anti-soiling processing, a fluorine anti-soiling agent containing a fluorine compound having a fluoroalkyl group is usually used to obtain an anti-soiling carpet with anti-soiling and water repellency properties imparted thereby. Such anti-soiling carpet prevents water to quickly penetrate therein and allows spills to be wiped away and stains to be removed easily.

Although a carpet treated with a fluorine-based anti-soiling agent exhibits excellent water repellency and anti-soiling property, the concern of the environmental load of the long-chain fluoroalkyl compound has become clear. Non-fluorinated anti-soiling agents that do not contain long-chain fluoroalkyl compounds and exhibit high anti-soiling and water repelling performance have been required internationally.

In recent years, research on non-fluorinated anti-soiling agents that do not contain fluorine has been conducted. For example, Japanese Unexamined Patent Publication No. 2004-532944 discloses a method for imparting soil resistance and stain resistance to a carpet by a composition containing a stain blocking agent, silsesquioxane and a surfactant. Further, Japanese Unexamined Patent Publication No. 2017-519117 discloses a carpet treated with a fiber protection composition containing a clay nanoparticle component, an acrylic copolymer component and water.

### SUMMARY

The present invention provides a method to manufacture an anti-soiling carpet with anti-soiling and water repellency properties while using a non-fluorinated compound. The present invention also describes an anti-soiling carpet with sufficient anti-soiling and water repellency properties without using a fluorinated compound with fluoroalkyl group.

The method of manufacturing an anti-soiling carpet in an embodiment of the present invention comprises a step of treating a carpet with a liquid solution containing an anti-soiling agent. The anti-soiling agent contains a non-fluorinated polymer (α) and a non-fluorinated polymer (0). The non-fluorinated polymer (α) contains a constituent unit derived from a monomer (A1) represented by formula (A-1) and a constituent unit derived from at least one monomer selected from the group consisting of a monomer (A2) represented by formula (A-2) and a monomer (A3) represented by formula (A-3), with a mixing ratio of the monomer (A1) of 60 mass % or more relative to the total amount of the monomer components constituting the non-fluorinated polymer (α). The non-fluorinated polymer (β) contains a constituent unit derived from at least one monomer (A4) of methyl methacrylate and ethyl methacrylate and a constituent unit derived from a monomer (A5) represented by formula (A-5), with a mixing ratio of the monomer (A4) of 60 mass % or more relative to the total amount of the monomer components constituting the non-fluorinated polymer (β).

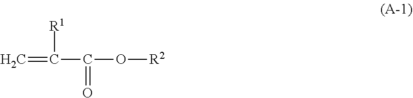

wherein R¹ represents a hydrogen atom or a methyl group, and R² represents a monovalent hydrocarbon group having 12 to 30 carbon atoms, optionally having a substituent;

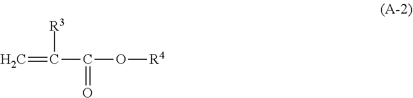

wherein R³ represents a hydrogen atom or a methyl group, and R⁴ represents a monovalent cyclic hydrocarbon group having 4 to 11 carbon atoms, optionally having a substituent, or a monovalent unsubstituted chain hydrocarbon group having 1 to 4 carbon atoms;

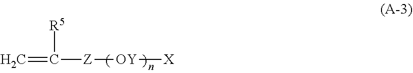

wherein R⁵ represents a hydrogen atom or a methyl group, X represents a hydroxyl group or a methoxy group, Y represents a linear or branched alkylene group having 2 to 4 carbon atoms, optionally having a hydroxyl group, Z represents a ketone group or a linear or branched alkylene group having 1 to 6 carbon atoms, n is an integer of 1 to 80, and in the case of n being 2 or more, the plurality of Y's may be the same or different from each other;

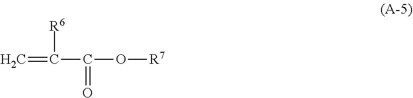

wherein R⁶ represents a hydrogen atom or a methyl group, and R⁷ represents a monovalent hydrocarbon group having 4 to 30 carbon atoms, optionally having a substituent.

In the method of manufacturing an anti-soiling carpet, the anti-soiling agent may further comprise a non-fluorinated polymer (γ) containing a constituent unit derived from at least one monomer (VC) of vinyl chloride and vinylidene chloride, with a mixing ratio of the monomer (VC) of 50 mass % or more relative to the total amount of the monomer components constituting the non-fluorinated polymer (γ).

Also, the anti-soiling agent may further comprise at least one of a non-fluorinated polymer (δ) and a polyester resin (ε), the non-fluorinated polymer (δ) containing a constituent unit derived from a monomer (A3) represented by formula (A-3), with a mixing ratio of the monomer (A3) of 60 mass % or more relative to the total amount of the monomer components constituting the non-fluorinated polymer (δ), wherein the polyester resin (s) may be a polyester resin represented by formula (B-1):

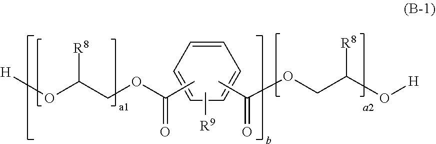

wherein R⁸ represents a hydrogen atom or a methyl group, R⁹ represents a hydrogen atom or a sodium sulfonate group, a1 and a2 each independently represent an integer of 1 to 200, b represents an integer of 1 to 20, the plurality of R⁸'s may be the same or different from each other, and in the case of b being 2 or more, the plurality of R⁹'s may be the same or different from each other.

Also, the anti-soiling agent may further comprise the non-fluorinated polymer (γ) and at least one of the non-fluorinated polymer (δ) and the polyester resin (ε).

In the anti-soiling carpet according to one aspect of the present invention, at least a pile portion has a non-fluorinated polymer (α) and a non-fluorinated polymer (β), the non-fluorinated polymer (α) containing a constituent unit derived from a monomer (A1) represented by formula (A-1) and a constituent unit derived from at least one monomer selected from the group consisting of a monomer (A2) represented by formula (A-2) and a monomer (A3) represented by formula (A-3), with a mixing ratio of the monomer (A1) of 60 mass % or more relative to the total amount of the monomer components constituting the non-fluorinated polymer (α), and the non-fluorinated polymer (β) containing a constituent unit derived from at least one monomer (A4) of methyl methacrylate and ethyl methacrylate and a constituent unit derived from a monomer (A5) represented by formula (A-5), with a mixing ratio of the monomer (A4) of 60 mass % or more relative to the total amount of the monomer components constituting the non-fluorinated polymer (β).

In the anti-soiling carpet, the pile part may further comprise a non-fluorinated polymer (γ), wherein the non-fluorinated polymer (γ) may contain a constituent unit derived from at least one monomer (VC) of vinyl chloride and vinylidene chloride, with a mixing ratio of the monomer (VC) of 50 mass % or more relative to the total amount of the monomer components constituting the non-fluorinated polymer (γ).

The pile portion may further comprise at least one of a non-fluorinated polymer (δ) and a polyester resin (ε), wherein the non-fluorinated polymer (δ) may contain a constituent unit derived from a monomer (A3) represented by formula (A-3), with a mixing ratio of the monomer (A3) of 60 mass % or more relative to the total amount of the monomer components constituting the non-fluorinated polymer (δ), and the polyester resin (ε) may be a polyester resin represented by formula (B-1).

Also, the pile portion may further comprise the non-fluorinated polymer (γ) and at least one of the non-fluorinated polymer (δ) and the polyester resin (ε).

The method for manufacturing an anti-soiling carpet in an embodiment of the present invention enables an anti-soiling carpet having sufficient anti-soiling and water repellency properties to be obtained even by using a non-fluorinated anti-soiling agent. The anti-soiling carpet in an embodiment of the present invention can have sufficient anti-soiling and water repellency properties without containing a fluorine compound having a fluoroalkyl group.

### DETAILED DESCRIPTION

In the present invention, “(meth)acrylate ester” refers to “acrylate ester” or “methacrylate ester” corresponding thereto, and the same applies to “(meth)acrylate” and “(meth)acrylamide”.

The method of manufacturing an anti-soiling carpet in the present embodiment comprises a step of treating a carpet with a liquid solution containing an anti-soiling agent.

The anti-soiling agent for use in the method of manufacturing an anti-soiling carpet in the present embodiment may contain a non-fluorinated polymer (α) and a non-fluorinated polymer (β) which are described below.

The non-fluorinated polymer (α) contains a constituent unit derived from a monomer (A1) represented by formula (A-1) (hereinafter also referred to as component (A1)) and a constituent unit derived from at least one monomer selected from the group consisting of a monomer (A2) represented by formula (A-2) (hereinafter also referred to as component (A2)) and a monomer (A3) represented by formula (A-3) (hereinafter also referred to as component (A3)), with a mixing ratio of the monomer (A1) of 60 mass % or more relative to the total amount of the monomer components constituting the non-fluorinated polymer (α).

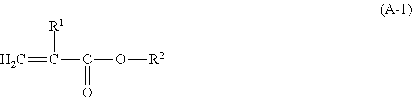

wherein R¹ represents a hydrogen atom or a methyl group, and R² represents a monovalent hydrocarbon group having 12 to 30 carbon atoms, optionally having a substituent;

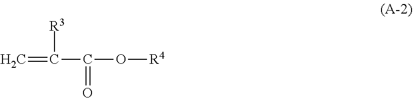

wherein R³ represents a hydrogen atom or a methyl group, and R⁴ represents a monovalent cyclic hydrocarbon group having 4 to 11 carbon atoms, optionally having a substituent, or a monovalent unsubstituted chain hydrocarbon group having 1 to 4 carbon atoms;

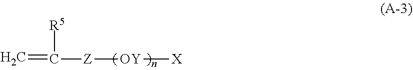

wherein R⁵ represents a hydrogen atom or a methyl group, X represents a hydroxyl group or a methoxy group, Y represents a linear or branched alkylene group having 2 to 4 carbon atoms, optionally having a hydroxyl group, Z represents a ketone group or a linear or branched alkylene group having 1 to 6 carbon atoms, n is an integer of 1 to 80, and in the case of n being 2 or more, the plurality of Y's may be the same or different from each other.

In the component (A1) constituting the non-fluorinated polymer (α), R² in the formula (A-1) is a monovalent hydrocarbon group having 12 to 30 carbon atoms, optionally having a substituent, in a linear form or in a branched form, and may be a saturated hydrocarbon group or an unsaturated hydrocarbon group in an aliphatic ring form or in an aromatic ring form. In particular, from the perspectives of anti-soiling and water repellency properties, a linear form is preferred, and a linear alkyl group is more preferred. In this case, better anti-soiling and water repellency properties can be achieved.

The carbon number of R² is preferably 12 to 24, and more preferably 12 to 22, from the same perspectives describe above. With a carbon number in the range, particularly excellent anti-soiling and water repellency properties can be achieved. A linear alkyl group having 12 to 18 carbon atoms is particularly preferred as R². From the perspective of water repellency, it is preferable that R² be an unsubstituted hydrocarbon group.

In the case of R² being a hydrocarbon group having a substituent, examples of the substituent include one or more of a hydroxyl group, an amino group, a carboxyl group, an epoxy group, an isocyanate group, a blocked isocyanate group, and a (meth)acryloyloxy group. In this case, a combined use of a cross-linking agent capable of reacting with the above group can further improve the anti-soiling durability of the resulting anti-soiling carpet. For example, the decline in the anti-soiling properties due to rubbing of the surface (e.g., pile portion) during use of the carpet is suppressed, so that the sufficient anti-soiling properties can be maintained for a longer period. The isocyanate group may form a blocked isocyanate group protected with a blocking agent. As the cross-linking agent, ones described below may be used.

In the case of the component (A1) having an amino group, the texture of the resulting anti-soiling carpet can be further improved.

From the perspective of water repellency, it is preferable that the component (A1) be a mono-functional (meth)acrylate ester monomer having one polymerizable unsaturated group in a molecule.

Examples of the component (A1) include stearyl (meth)acrylate, cetyl (meth)acrylate, lauryl (meth)acrylate, myristyl (meth)acrylate, pentadecyl (meth)acrylate, heptadecyl (meth)acrylate, nonadecyl (meth)acrylate, eicosyl (meth)acrylate, heneicosyl (meth)acrylate, behenyl (meth)acrylate, ceryl (meth)acrylate, and melissyl (meth)acrylate.

One of the components (A1) may be used singly or two or more thereof may be used in combination.

The component (A2) capable of constituting a non-fluorinated polymer (α) includes R⁴ in the formula (A-2), which is a monovalent cyclic hydrocarbon group having 4 to 11 carbon atoms or an unsubstituted monovalent chain hydrocarbon group having 1 to 4 carbon atoms. Examples of the cyclic hydrocarbon group include saturated or unsaturated single ring groups, multiple ring groups and bridged ring groups. From the perspective of anti-soiling properties, the cyclic hydrocarbon groups are preferably saturated ones, more preferably saturated cyclic aliphatic groups. The carbon number of the cyclic hydrocarbon groups is preferably 4 to 11, more preferably 6 to 10. With a carbon number in the range, the anti-soiling properties are particularly improved.

The cyclic hydrocarbon groups may have a chain group (e.g., a linear or branched hydrocarbon group) as substituent. In the case of the substituent being a hydrocarbon group, a hydrocarbon group having a total carbon number of the substituent and the cyclic hydrocarbon group of 11 or less is selected.

Specific examples of the cyclic hydrocarbon group include a cyclohexyl group, a tert-butyl cyclohexyl group, an isobornyl group, a dicyclopentanyl group, a dicyclopentenyl group, and an adamantyl group.

Examples of the component (A2) having a cyclic hydrocarbon group include cyclohexyl (meth)acrylate, tert-butylcyclohexyl (meth)acrylate, benzyl (meth)acrylate, isobornyl (meth)acrylate, dicyclopentanyl (meth)acrylate, dicyclopentenyl (meth)acrylate, dicyclopentanyloxyethyl (meth)acrylate, tricyclopentanyl (meth)acrylate, adamantyl (meth)acrylate, 2-methyl-2-adamantyl (meth)acrylate, and 2-ethyl-2-adamanthyl (meth)acrylate.

Examples of the component (A2) having a chain hydrocarbon group include methyl methacrylate, ethyl (meth)acrylate, n-butyl (meth)acrylate, isobutyl (meth)acrylate, and tert-butyl (meth)acrylate.

The component (A2) may have at least one functional group capable of reacting with a cross-linking agent, selected from the group consisting of a hydroxyl group, an amino group, a carboxyl group, an epoxy group, and an isocyanate group. In this case, the anti-soiling durability of the resulting carpet can be further improved. The isocyanate group may form a blocked isocyanate group protected with a blocking agent. Examples of the cross-linking agent for use include those described below.

In the case of the component (A2) having an amino group, the texture of the resulting anti-soiling carpet can be further improved.

Examples of the component (A2) having an isocyanate group or an amino group include dimethylaminoethyl (meth)acrylate.

From the perspective of anti-soiling properties, it is preferable that the component (A2) be a monofunctional (meth)acrylate ester monomer having one polymerizable unsaturated group in a molecule.

One of the components (A2) may be used singly, or two or more thereof may be used in combination.

The component (A3) capable of constituting the non-fluorinated polymer (α) includes Y in formula (A-3), which is a linear or branched alkylene group having 2 to 4 carbon atoms, optionally having a hydroxyl group. From the perspective of anti-soiling properties, it is preferable that the carbon number be 2.

The Z in formula (A-3) is a ketone group or a linear or branched alkylene group having 1 to 6 carbon atoms, and from the perspective of anti-soiling properties, it is preferable that Z be a ketone group.

From the perspectives of anti-soiling and water repellency properties, the n in formula (A-3) is an integer of 1 to 80, preferably 1 to 50, more preferably 1 to 40, still more preferably 1 to 30.

Examples of the component (A3) include 2-hydroxyethyl (meth)acrylate, hydroxybutyl (meth)acrylate, methoxypolyethylene glycol (meth)acrylate, polyoxybutylene/ethylene alkenyl ether, and glycerol monomethacrylate. In particular, from the perspective of anti-soiling properties, methoxypolyethylene glycol (meth)acrylate is preferred.

One of the components (A3) may be used singly, or two or more thereof may be used in combination.

From the perspective of water repellency, the content of the constituent unit derived from the component (A1) in the non-fluorinated polymer (α) expressed in the mixing ratio of the component (A1) relative to the total amount of the monomer components constituting the non-fluorinated polymer (α) is preferably 60 to 99 mass %, more preferably 65 to 95 mass %, still more preferably 70 to 95 mass %.

Also, from the perspective of water repellency, the mixing amount of the component (A1), the component (A2) and the component (A3) in total is preferably 80 to 100 mass %, more preferably 85 to 100 mass %, still more preferably 90 to 100 mass %, relative to the total amount of the monomer components constituting the non-fluorinated polymer (α).

From the perspective of easily improving the anti-soiling properties and the water repellency of the resulting anti-soiling carpet, the weight average molecular weight of the non-fluorinated polymer (α) is preferably 10000 or more, and more preferably 50000 or more. From the perspective of imparting the anti-soiling properties and the water repellency at a further higher level to the carpet. From the perspective of anti-soiling properties, the weight average molecular weight of the non-fluorinated polymer (α) may be 5000000 or less, and is preferably 2000000 or less.

In the present invention, the weight average molecular weight of a polymer refers to a value measured using a GPC apparatus (GPC “HLC-8020” manufactured by Tosoh Corporation), under conditions such that a temperature of the column is 40° C., a flow rate is 1.0 ml/min, and using tetrahydrofuran as eluent, in terms of standard polystyrene. Three pieces including TSK-GEL G5000HHR, G4000HHR and G3000HHR, which are trade names, manufactured by Tosoh Corporation, are used as a column.

Next, the non-fluorinated polymer (β) is described.

The non-fluorinated polymer (β) comprises a constituent unit derived from at least one monomer (A4) of methyl methacrylate and ethyl methacrylate (hereinafter also referred to as component (A4)) and a constituent unit derived from the monomer (A5) represented by formula (A-5) (herein after also referred to as component (A5)), with a mixing ratio of the monomer (A4) of 60 mass % or more relative to the total amount of the monomer components constituting the non-fluorinated polymer (β).

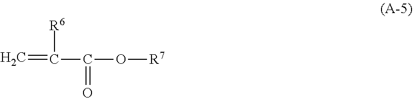

wherein R⁶ represents a hydrogen atom or a methyl group, and R⁷ represents a monovalent hydrocarbon group having 4 to 30 carbon atoms, optionally having a substituent.

From the perspective of anti-soiling properties, the content of the constituent unit derived from the component (A4) in the non-fluorinated polymer (β) expressed in the mixing ratio of the component (A4) relative to the total amount of the monomer components constituting the non-fluorinated polymer (β) is preferably 60 to 99 mass %, more preferably 65 to 95 mass %, still more preferably 70 to 95 mass %.

In the component (A5) constituting the non-fluorinated polymer (β), R⁷ in formula (A-5) is a monovalent hydrocarbon group having 4 to 30 carbon atoms, optionally having a substituent, and may be in a linear form or in a branched form, and, further, may be a saturated hydrocarbon group or an unsaturated hydrocarbon group, and, further, may be in an aliphatic ring form or in an aromatic ring form. In particular, from the perspectives of anti-soiling and water repellency properties, a linear form is preferred, and a linear alkyl group is more preferred. In this case, better anti-soiling and water repellency properties can be achieved.

The carbon number of R⁷ is preferably 4 to 18, more preferably 4 to 8 or 10 to 18, from the same perspective described above. With a carbon number in the range, particularly excellent anti-soiling and water repellency properties can be achieved. With a carbon number of 4 to 8, anti-soiling properties are particularly improved, and with a carbon number of 10 to 18, water repellency tends to be particularly improved. A linear alkyl group having 4 to 6 or 16 to 18 carbon atoms is particularly preferred as R⁷.

From the perspectives of anti-soiling properties, it is preferable that the component (A5) be a monofunctional (meth)acrylate ester monomer having one polymerizable unsaturated group in a molecule.

Examples of the component (A5) include butyl (meth)acrylate, pentyl (meth)acrylate, hexyl (meth)acrylate, heptyl (meth)acrylate, octyl (meth)acrylate, nonyl (meth)acrylate, decyl (meth)acrylate, undecyl (meth)acrylate, dodecyl (meth)acrylate, tetradecyl (meth)acrylate, hexadecyl (meth)acrylate, octadecyl (meth)acrylate, and isobornyl (meth)acrylate.

The component (A5) may have at least one functional group capable of reacting with a cross-linking agent, selected from the group consisting of a hydroxyl group, an amino group, a carboxyl group, an epoxy group and an isocyanate group. In this case, the anti-soiling durability of the resulting anti-soiling carpet can be further improved. The isocyanate group may form a blocked isocyanate group protected with a blocking agent. As the cross-linking agent, ones described below can be used.

In the case of the component (A5) having an amino group, the texture of the resulting anti-soiling carpet can be further improved.

Examples of the component (A5) having an isocyanate group or an amino group include dimethylaminoethyl (meth)acrylate.

One of the components (A5) may be used singly, or two or more thereof may be used in combination.

From the perspective of anti-soiling properties, the mixing amount of the component (A4) and the component (A5) in total relative to the total amount of the monomer components constituting the non-fluorinated polymer (β) is preferably 80 to 100 mass %, more preferably 85 to 100 mass %, still more preferably 90 to 100 mass %.

From the perspective of easily improving the anti-soiling properties and the water repellency of the resulting anti-soiling carpet, the weight average molecular weight of the non-fluorinated polymer (β) is preferably 10000 or more, and more preferably 50000 or more. From the perspective of anti-soiling properties, the weight average molecular weight of the non-fluorinated polymer (β) may be 5000000 or less, and is preferably 2000000 or less.

From the perspective of anti-soiling properties, the anti-soiling agent for use in the manufacturing method in the present embodiment has a content of the non-fluorinated polymer (α) of preferably 30 to 80 mass %, more preferably 30 to 60 mass %, relative to the total amount of the non-fluorinated polymer (α) and the non-fluorinated polymer (β).

From the perspective of water repellency, it is preferable that the anti-soiling agent further comprise a non-fluorinated polymer (γ) described below.

The non-fluorinated polymer (γ) comprises a constituent unit derived from at least one monomer (VC) of vinyl chloride and vinylidene chloride (hereinafter also referred to as “component (VC)”), with a mixing ratio of the monomer (VC) of 50 mass % or more relative to the total amount of the monomer components constituting the non-fluorinated polymer (γ).

From the perspective of water repellency, the content of the constituent unit derived from the component (VC) in the non-fluorinated polymer (γ) expressed in the mixing ratio of the component (VC) relative to the total amount of the monomer components constituting the non-fluorinated polymer (γ) is preferably 50 to 100 mass %, more preferably 60 to 100 mass %, still more preferably 60 to 95 mass %.

The non-fluorinated polymer (γ) may further comprise a constituent unit derived from the component (A1), and the content thereof expressed in the mixing ratio of the component (A1) relative to the total amount of the monomer components constituting the non-fluorinated polymer (γ) may be 0 to 50 mass %.

In the case of the non-fluorinated polymer (γ) containing a constituent unit derived from the component (A1), from the perspective of water repellency, the content ratio between the constituent unit derived from the component (A1) and the constituent unit derived from the component (VC) expressed in the mixing ratio between the component (A1) and the component (VC), i.e., [(A1)/(VC)], is preferably 40/60 to 1/99, more preferably 35/65 to 10/90.

From the perspective of water repellency, the mixing amount of the component (A1) and the component (VC) in total relative to the total amount of the monomer components constituting the non-fluorinated polymer (γ) is preferably 80 to 100 mass %, more preferably 85 to 100 mass %, still more preferably 90 to 100 mass %.

From the perspective of imparting anti-soiling and water repellency properties to the carpet at a further higher level, the weight average molecular weight of the non-fluorinated polymer (γ) is preferably 10000 or more, from the perspective of further improving the anti-soiling and the water repellency properties of the resulting anti-soiling carpet, more preferably 50000 or more. From the perspective of anti-soiling properties, the weight average molecular weight of the non-fluorinated polymer (γ) may be 5000000 or less, and is preferably 2000000 or less.

From the perspective of water repellency, the content of the non-fluorinated polymer (γ) in the anti-soiling agent in the present embodiment is preferably 1 to 50 mass %, more preferably 1 to 40 mass %, relative to the total amount of the non-fluorinated polymer (α) and the non-fluorinated polymer (β).

From the perspective of anti-soiling properties, it is preferable that the anti-soiling agent further comprise at least one of a non-fluorinated polymer (δ) and a polyester resin (ε) described below.

The non-fluorinated polymer (δ) comprises a constituent unit derived from the component (A3), with a mixing ratio of the component (A3) of 60 mass % or more relative to the total amount of the monomer components constituting the non-fluorinated polymer (δ).

From the perspective of anti-soiling properties, the content of the constituent unit derived from the component (A3) in the non-fluorinated polymer (δ) expressed in the mixing ratio of the component (A3) relative to the total amount of the monomer components constituting the non-fluorinated polymer (δ) is preferably 60 to 100 mass %, more preferably 60 to 90 mass %, still more preferably 60 to 80 mass %.

The non-fluorinated polymer (δ) may further comprise a constituent unit derived from the component (A1), with a content thereof expressed in the mixing ratio of the component (A1) relative to the total amount of the monomer components constituting the non-fluorinated polymer (δ) of 0 to 40 mass %.

From the perspective of anti-soiling properties, the amount of the component (A1) and the component (A3) in total relative to the total amount of the monomer components constituting the non-fluorinated polymer (δ) is preferably 80 to 100 mass %, more preferably 85 to 100 mass %, still more preferably 90 to 100 mass %.

From the perspective of imparting anti-soiling and water repellency properties to the carpet at a higher level, the weight average molecular weight of the non-fluorinated polymer (δ) is preferably 10,000 or more, from the perspective of further improving the anti-soiling and the water repellency properties of the resulting anti-soiling carpet, and more preferably 50,000 or more. From the perspective of anti-soiling properties, the weight average molecular weight of the non-fluorinated polymer (δ) may be 5,000,000 or less, and is preferably 2,000,000 or less.

From the perspective of anti-soiling properties, the content of the non-fluorinated polymer (δ) in the anti-soiling agent in the present embodiment is preferably 1 to 29 mass %, more preferably 10 to 29 mass %, relative to the total amount of the non-fluorinated polymer (α) and the non-fluorinated polymer (β).

The polyester resin (ε) is a polyester resin represented by formula (B-1).

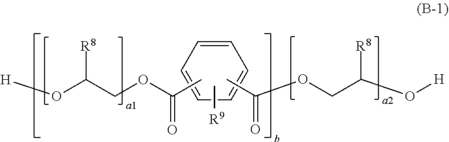

wherein R⁸ represents a hydrogen atom or a methyl group, R⁹ represents a hydrogen atom or a sodium sulfonate group, a1 and a2 each independently represent an integer of 1 to 200, b represents an integer of 1 to 20, the plurality of R⁸'s may be the same or different from each other, and in the case of b being 2 or more, the plurality of R⁹'s may be the same or different from each other.

In the polyester resin (ε), from the perspective of anti-soiling properties, it is preferable that R⁸ be a hydrogen atom, and from the perspective of anti-soiling properties and the water repellency, it is preferable that R⁹ be a hydrogen atom.

In the polyester resin (ε), from the perspective of water repellency and anti-soiling properties, a1 is 1 to 200, preferably 1 to 150, more preferably 1 to 100, and a2 is 1 to 200, preferably 1 to 150, and more preferably 1 to 100.

In the polyester resin (ε), from the perspective of anti-soiling properties, b is 1 to 20, preferably 3 to 16.

From the perspective of anti-soiling and water repellency properties, the weight average molecular weight of the polyester resin (δ) is preferably 10000 or more, more preferably 15000 or more. In this case, it is easy to impart sufficient water repellency to the resulting anti-soiling carpet.

From the perspective of anti-soiling properties, the content of the polyester resin (ε) in the anti-soiling agent in the present embodiment is preferably 1 to 30 mass %, more preferably 1 to 25 mass %, relative to the total amount of the non-fluorinated polymer (α) and the non-fluorinated polymer (β).

The non-fluorinated polymers (α), (β), (γ), and (δ) may comprise a constituent unit derived from a monofunctional monomer (D) other than the above monomer components, copolymerizable therewith (hereinafter also referred to as component (D)), within a range without impairing the effect of the present invention.

Examples of the component (D) include vinyl monomers not containing fluorine other than the component (VC), such as (meth)acrylate esters having a hydrocarbon group other than the component (A1), the component (A2), the component (A4) and the component (A5) (hereinafter also referred to as “other (meth)acrylate esters”), (meth)acrylates, fumarate esters, maleate esters, fumaric acid, maleic acid, (meth)acrylamide, N-methylol acrylamide, vinyl ethers, vinyl esters, (meth)acrylonitrile, dimethylaminoethyl (meth)acrylate, ethylene and styrene. Incidentally, in the other (meth)acrylate esters, the hydrocarbon group may have a substituent such as a vinyl group, a hydroxyl group, an amino group, an epoxy group, and an isocyanate group or a blocked isocyanate group; a substituent other than a group capable of reacting with a cross-linking agent such as a quaternary ammonium group; an ether bond, an ester bond, an amide bond or an urethane bond. Examples of the other (meth)acrylate esters include ethylene glycol di(meth)acrylate.

To the anti-soiling agent for use in the method of manufacturing an anti-soiling carpet in the present embodiment, additives may be added on an as needed basis. Examples of the additives include a water repellent, a surfactant, a defoaming agent, a pH adjuster, an antimicrobial agent, a fungicide, a colorant, an antioxidant, a deodorant agent, various organic solvents, a chelating agent, an antistatic agent, a catalyst, a cross-linking agent, an antimicrobial deodorant agent, a flame retardant, a fabric softener, and an anti-creasing agent.

As the surfactant, a conventionally known nonionic surfactant, anionic surfactant, cationic surfactant, or amphoteric surfactant may be used. One of the surfactants may be used singly, or two or more thereof may be used in combination.

Examples of the defoaming agent include an oil and fat defoaming agent such as castor oil, sesame oil, linseed oil, and animal and vegetable oils; a fatty acid defoaming agent such as stearic acid, oleic acid, and palmitic acid; a fatty acid ester defoaming agent such as isoamyl stearate, distearyl succinate, ethylene glycol distearate, and butyl stearate; an alcohol defoaming agent such as polyoxyalkylene monohydric alcohol, di-tert-amylphenoxy ethanol, 3-heptanol, and 2-ethyl hexanol; di-tert-amylphenoxy ethanol, 3-heptyl cellosolve, nonyl cellosolve, and 3-heptyl carbitol; a phosphate ester defoaming agent such as tributyl phosphate and tris(butoxyethyl)phosphate; an amine defoaming agent such as diamylamine; an amide defoaming agent such as polyalkylene amide and acylate polyamine; a sulfate ester defoaming agent such as sodium lauryl sulfate; and mineral oils. One of the defoaming agents may be used singly, or two or more thereof may be used in combination.

Examples of the pH adjuster include an organic acid such as lactic acid, acetic acid, propionic acid, maleic acid, oxalic acid, formic acid, citric acid, malic acid, sulfonic acid, methane sulfonic acid, and toluene sulfonic acid; an inorganic acid such as hydrochloric acid, sulfonic acid, nitric acid, phosphoric acid, and boric acid; and a base such as sodium hydroxide, potassium hydroxide, calcium hydroxide, barium hydroxide, ammonia, alkanolamine, pyridine and morpholine. One of the pH adjusters may be used singly, or two or more thereof may be used in combination.

Examples of the organic solvent include aliphatic alcohols having 1 to 8 carbon atoms such as methanol, ethanol, isopropyl alcohol, isobutyl alcohol, hexyl alcohol, 2-ethylhexyl alcohol; ketones such as acetone, methyl ethyl ketone, methyl isobutyl ketone, diisobutyl ketone, cyclohexanone, and diacetone alcohol; esters such as ethyl acetate, methyl acetate, butyl acetate, methyl lactate and ethyl lactate; ethers such as diethyl ether, diisopropyl ether, methyl cellosolve, ethyl cellosolve, butyl cellosolve, dioxane, methyl tert-butyl ether, and butyl carbitol; glycols such as ethylene glycol, diethylene glycol, triethylene glycol, propylene glycol, and dipropylene glycol; glycol ethers such as ethylene glycol monobutyl ether, diethylene glycol monobutyl ether, diethylene glycol monomethyl ether, triethylene glycol monomethyl ether, propylene glycol monomethyl ether, and 3-methoxy-3-methyl-1-butanol; glycol esters such as ethylene glycol monomethyl ether acetate, propylene glycol monomethyl ether acetate, diethylene glycol monoethyl ether acetate; and amides such as formamide, acetamide, benzamide, N,N-dimethylformamide, and acetanilide. One of the organic solvents may be used singly, or two or more thereof may be used in combination.

As the antistatic agent, ones which hardly impair the performance of water repellency are suitable for use. Examples of the antistatic agent include a cationic surfactant such as higher alcohol sulfonate esters, sulfonated oils, sulfonates, quaternary ammonium salts, imidazoline quaternary salts; nonionic surfactants of polyethylene glycol-type and polyhydric alcohol ester-type; amphoteric surfactants of imidazoline quaternary salts, alanine-type and betaine-type; antistatic polymers of macromolecular compound-type, and polyalkylamines. One of the antistatic agents may be used singly, or two or more thereof may be used in combination.

Next, a method of manufacturing the non-fluorinated polymers (α), (β), (γ), and (δ) is described.

The non-fluorinated polymers (α), (β), (γ), and (δ) may be manufactured by radical polymerization methods. Among the radical polymerization methods, from the perspectives of performance of the resulting water repellent and environmental aspect, an emulsion polymerization method or a dispersion polymerization method is preferred.

For example, the non-fluorinated polymer (α) may be obtained by emulsion polymerization or dispersion polymerization of the component (A1) and the component (A2) and/or the component (A3) in a medium. More specifically, for example, the component (A1), the component (A2) and/or the component (A3) are added to a medium together with the component (D) and a co-emulsifier or co-dispersant on an as needed basis, and the mixture is emulsified or dispersed to obtain an emulsion or dispersion. A polymerization initiator is added to the resulting emulsion or dispersion for initiation of a polymerization reaction, so that the monomers and the reactive emulsifier can be polymerized. Examples of the means for emulsifying or dispersing the mixture include a homo mixer, a high-pressure emulsifier or ultrasonic waves. The non-fluorinated polymers (β), (γ), and (δ) also may be manufactured in the same manner. In other words, the polymerization can be performed in the same manner as in the above, using the component (A4) and the component (A5) in the case of the non-fluorinated polymer (β), the component (VC) in the case of the non-fluorinated polymer (γ), and the component (A3) in the case of the non-fluorinated polymer (δ), instead of the component (A1), the component (A2) and/or the component (A3).

As the co-emulsifier or the co-dispersant (hereinafter also referred to as “co-emulsifier and the like”), one or more selected from a nonionic surfactant, a cationic surfactant, an anionic surfactant and an amphoteric surfactant may be used. The content of the co-emulsifier and the like is preferably 0.5 to 30 parts by mass, more preferably 1 to 20 parts by mass, still more preferably 1 to 10 parts by mass, relative to 100 parts by mass of the entire monomers. With a content of the co-emulsifier and the like of less than 0.5 parts by mass, the dispersion stability of the liquid mixture tends to decrease in comparison with a case where the content of the co-emulsifier and the like is within the range, and with a content of the emulsifier and the like of more than 30 parts by mass, the water repellency of the resulting non-fluorinated polymer tends to decrease in comparison with a case where the content of the co-emulsifier and the like is within the range.

Examples of the cationic surfactant include monoalkyltrimethyl ammonium salts having 8 to 24 carbon atoms, dialkyldimethyl ammonium salts having 8 to 24 carbon atoms, monoalkylamine acetate salts having 8 to 24 carbon atoms, dialkylamine acetate salts having 8 to 24 carbon atoms, and alkylimidazoline quaternary salts having 8 to 24 carbon atoms. Among them, from the perspective of emulsification and processing stability, monoalkyltrimethyl ammonium salts having 12 to 18 carbon atoms and dialkyldimethyl ammonium salts having 12 to 18 carbon atoms are preferred. One of the cationic surfactants may be used singly, or two or more thereof may be used in combination.

Examples of the anionic surfactant include anionized products of linear chain or branched chain alcohols or alkenols having 8 to 24 carbon atoms, anionized products of alkylene oxide adducts of linear chain or branched chain alcohols or alkenols having 8 to 24 carbon atoms, anionized products of alkylene oxide adducts of polycyclic phenols, anionized products of alkylene oxide adducts of linear chain or branched chain aliphatic amines having 8 to 44 carbon atoms, anionized products of alkylene oxide adducts of linear chain or branched chain aliphatic amides having 8 to 44 carbon atoms, and anionized products of alkylene oxide adducts of linear chain or branched chain fatty acids having 8 to 24 carbon atoms. One of the anionic surfactants may be used singly, or two or more thereof may be used in combination.

Examples of the amphoteric surfactant include amphoteric surfactants of amino acid-type, betaine-type, sulfonate ester salt-type, sulfonate salt-type, and phosphonate ester salt-type. One of the amphoteric surfactants may be used singly, or two or more thereof may be used in combination.

Examples of the nonionic surfactant include alkylene oxide adducts of alcohols, polycyclic phenols, amines, amides, fatty acids, polyhydric alcohol fatty acid esters, oils and fats, and polypropylene glycol. One of the nonionic surfactants may be used singly, or two or more thereof may be used in combination.

Examples of the alcohol include linear chain or branched chain alcohols or alkenols having 8 to 24 carbon atoms, and acetylene alcohols represented by formula (AL-1) or formula (AL-2).

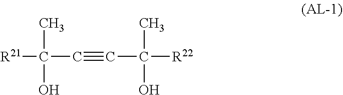

wherein R²¹ and R²² each independently represent an alkyl group having a linear chain or a branched chain with 1 to 8 carbon atoms, or an alkenyl group having a linear chain or a branched chain with 2 to 8 carbon atoms.

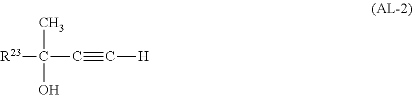

wherein R²³ represents an alkyl group having a linear chain or a branched chain with 1 to 8 carbon atoms, or an alkenyl group having a linear chain or a branched chain with 2 to 8 carbon atoms.

Examples of the polycyclic phenol include monovalent phenols such as phenol and naphthol which may have a hydrocarbon group having 1 to 12 carbon atoms, styrene (styrene, α-methylstyrene and vinyltoluene) adducts thereof, or reaction products thereof with benzyl chloride. Examples of the amines include linear chain or branched chain aliphatic amines having 8 to 44 carbon atoms.

Examples of the amides include linear chain or branched chain fatty acid amides having 8 to 44 carbon atoms.

Examples of the fatty acids include linear chain or branched chain fatty acids having 8 to 24 carbon atoms.

Examples of the polyhydric alcohol fatty acid esters include condensation reaction products between a polyhydric alcohol and a linear chain or branched chain fatty acid having 8 to 24 carbon atoms.

Examples of the oils and fats include vegetable oils and fats, animal oils and fats, vegetable waxes, animal waxes, mineral waxes and hydrogenated oils.

Among them, from the perspectives of less effect on the water repellency and anti-soiling properties, less effect on the light stability, and improvement in the emulsification of copolymers, linear chain or branched chain alcohols or alkenols having 8 to 24 carbon atoms and acetylene alcohols represented by formula (AL-1) or formula (AL-2) are preferred, and linear chain or branched chain alcohols having 8 to 24 carbon atoms and acetylene alcohols represented by formula (AL-1) or formula (AL-2) are more preferred.

Examples of the alkylene oxides include ethylene oxide, 1,2-propylene oxide, 1,2-butylene oxide, 2,3-butylene oxide, 1,4-butylene oxide, styrene oxide, and epichlorohydrin. From the perspectives of less effect on the water repellency and the anti-soiling properties and improvement in the emulsification of copolymers, ethylene oxide and 1,2-propylene oxide are preferred, and ethylene oxide is more preferred as the alkylene oxide.

The number of moles of alkylene oxide added is preferably 1 to 200, more preferably 3 to 100, still more preferably 5 to 50. With the number of moles of alkylene oxide added in the range, a higher level of the water repellency, the anti-soiling properties and the production stability can be easily obtained. With the number of moles of alkylene oxide added less than 1, the production stability, the water repellency and the anti-soiling properties tend to decrease, and with the number of moles of alkylene oxide added of more than 200, the water repellency and the anti-soiling properties tend to decrease.

In the non-fluorinated polymer in the present embodiment, use of a nonionic surfactant having an HLB of 7 to 18 as the nonionic surfactant allows a better water dispersion to be obtained. The HLB refers to Griffin's HLB value obtained from the following formula modified from the Griffin's one. In the formula, the hydrophilic group refers to an ethylene oxide group:

HLB=(Hydrophilic group×20)/Molecular weight

From the perspectives of the emulsion stability in the composition during and after emulsion polymerization or dispersion polymerization of the non-fluorinated polymer in the present embodiment (hereinafter simply referred to as emulsion stability), it is preferable that the HLB of the nonionic surfactant be 7 to 18, and the HLB of 9 to 15 is preferable. Furthermore, from the perspective of the storage stability of the anti-soiling agent, it is more preferred that two or more nonionic surfactants having a different HLB in the range be used in combination. Also, from the perspectives of emulsion stability and water repellency, it is preferable that a cationic surfactant and a nonionic surfactant be used in combination.

As the medium for emulsion polymerization or dispersion emulsion, water is preferred, and on an as needed basis, water and an organic solvent may be mixed. In the case, the type of organic solvent is not particularly limited so long as the organic solvent has miscibility with water, and examples thereof include alcohols such as methanol and ethanol, esters such as ethyl acetate, ketones such as acetone and methyl ethyl ketone, ethers such as diethyl ether, and glycols such as propylene glycol, dipropylene glycol and tripropylene glycol. The ratio between water and the organic solvent is not particularly limited.

As the polymerization initiator, conventionally known polymerization initiators of azo-type, peroxide-type, or redox-type may be appropriately used. It is preferable that the content of the polymerization initiator be 0.01 to 2 parts by mass relative to 100 parts by mass of entire monomers. With a content of the polymerization initiator in the range, a non-fluorinated polymer having a weight average molecular weight of 10000 or more can be efficiently manufactured.

Also, in the polymerization reaction, a chain-transfer agent such as dodecyl mercaptan and tert-butyl alcohol may be used for adjustment of the molecular weight. The content of the chain-transfer agent is preferably 0.5 parts by mass or less, more preferably 0.2 parts by mass or less, relative to 100 parts by mass of the entire monomers. With a chain-transfer agent content of more than 0.5 parts by mass, efficient manufacturing of a non-fluorinated polymer having a weight-average molecular weight of 10000 or more tends to become difficult due to reduction in the molecular weight.

A polymerization inhibitor may be used for adjustment of the molecular weight. With addition of a polymerization inhibitor, a non-fluorinated polymer having a desired weight average molecular weight can be easily obtained.

It is preferable that the temperature of polymerization reaction be 20° C. to 150° C. With a temperature of less than 20° C., the polymerization tends to become insufficient in comparison with a temperature in the range, while with a temperature of more than 150° C., the control of the reaction heat may become difficult in some cases.

In the polymerization reaction, the weight average molecular weight of the resulting non-fluorinated polymer can be adjusted through increase and decrease of the content of the polymerization initiator, the chain transfer agent, and the polymerization inhibitor described above.

From the perspective of the storage stability and handling ability of the composition, the content of the non-fluorinated polymer in the polymer emulsion or the dispersion obtained in emulsion polymerization or dispersion polymerization is set preferably at 10 to 50 mass %, more preferably at 20 to 40 mass %, relative to the total amount of the emulsion or the dispersion.

Next, the step of treating a carpet with a liquid solution containing an anti-soiling agent is described.

In the step, a carpet is treated with a liquid solution containing the anti-soiling agent in the present embodiment described above, so that the anti-soiling agent containing the non-fluorinated polymer (α) and the non-fluorinated polymer (β), and on an as needed basis, the non-fluorinated polymer (γ), the non-fluorinated polymer (δ) and the polyester resin (ε) can be adhered to the carpet. Thereby, the carpet is imparted with anti-soiling and water repellency properties.

The material of the carpet is not particularly limited, and examples thereof include natural fiber such as cotton, hemp, silk and wool, semi-synthetic fiber such as rayon and acetate, synthetic fiber such as nylon, polyester, polyurethane and polypropylene, and composite fiber thereof and mixed yarn. The carpet may be a product or an intermediate before being processed into a product.

Examples of the method of treating a carpet with the liquid solution include a processing method such as dipping, spraying, foaming and coating. In the case where the liquid solution contains water, it is preferable that the water be removed by drying after adhesion to the carpet.

The amount of the anti-soiling agent adhered to the carpet may be appropriately adjusted depending on the required degree of the anti-soiling and water repellency properties, and the total adhered amount of the non-fluorinated polymers (α) and (β) contained in the liquid solution is adjusted to, preferably 0.01 to 10 g, more preferably 0.05 to 5 g, relative to 100 g of the carpet. In the case where the total adhered amount is 0.01 g or more, the carpet tends to exhibit sufficient water repellency in comparison with the case where the total adhered amount is out of the range, while in the case of 10 g or less, the texture of the carpet tends to be improved in comparison with the case where the total adhered amount is out of the range.

Moreover, after making an anti-soiling processing agent adhere to a carpet, it is preferable to heat-process suitably. The temperature condition is not particularly limited, but when the anti-soiling agent according to the present embodiment is used, the carpet can exhibit sufficiently good anti-soiling and water repellency properties under mild conditions of 100 to 130° C. The temperature condition may be a high temperature treatment of 130° C. or higher (preferably up to 200° C.), but in such a case, the treatment time can be shortened compared to the conventional case using a fluorine-based water repellent. Therefore, according to the method for producing the anti-soiling carpet of the present embodiment, deterioration of the carpet due to heat is suppressed, and the texture of the carpet at the time of anti-soiling processing becomes soft. Mild heat treatment conditions, ie, low temperature curing conditions provides sufficient stain resistance and water repellency properties to the anti-soiling carpet.

In the case where improvement in anti-soiling durability is particularly required, it is preferred that a carpet be subjected to anti-soiling treatment by a method comprising the above step of treating the carpet with the liquid solution containing an anti-soiling agent, and a step of adhering a cross-linking agent typified by a melamine resin, a glyoxal resin, and a compound having one or more isocyanate group or a blocked isocyanate group to the carpet to be heated. In the case where further improvement in anti-soiling durability is desired, it is preferable that the anti-soiling agent comprise the non-fluorinated polymer (α) and/or the non-fluorinated polymer (β) which are copolymerized with a monomer having a functional group capable of reacting with the above cross-linking agent.

As the melamine resin, a compound having a melamine skeleton may be used, and examples thereof include polymethylol melamines such as trimethylol melamine and hexamethylol melamine; alkoxymethyl melamines having an alkoxymethyl group having an alkyl group having 1 to 6 carbon atoms, derived from a part or all of the methylol groups of a polymethylol melamine; and acyloxymethyl melamines having acyloxymethyl group having an acyl group having 2 to 6 carbon atoms derived from a part or all of the methylol groups of a polymethylol melamine. These melamine resins may be prepared by using any of a monomer or a dimer or a higher order multimer, or a mixture thereof. Also, a part of the melamine may be co-condensed with urea or the like for use. Examples of the melamine resin include BECKAMINE APM, BECKAMINE M-3, BECKAMINE M-3(60), BECKAMINE MA-S, BECKAMINE J-101 and BECKAMINE J-101LF manufactured by DIC Corporation, UNIKA RESIN 380K manufactured by Union Chemical Industry Co., Ltd., and RIKEN RESIN MM series manufactured by Mikiriken Industrial Co., Ltd.

As the glyoxal resin, conventionally known glyoxal resin may be used. Examples of the glyoxal resin include 1,3-dimethyl glyoxal urea resin, dimethylol dihydroxyethylene urea resin, and dimethylol dihyroxypropylene urea resin. The functional group of these resins may be substituted with another functional group. Examples of the glyoxal resin include BECKAMINE N-80, BECKAMINE NS-11, BECKAMINE LF-K, BECKAMINE NS-19, BECKAMINE LF-55P CONC., BECKAMINE NS-210L, BECKAMINE NS-200, and BECKAMINE NF-3 manufactured by DIC Corporation, UNIRESIN GS-20E manufactured by Union Chemical Industry Co., Ltd., and RIKEN RESIN RG series and RIKEN RESIN MS series manufactured by Mikiriken Industrial Co., Ltd.

For the melamine resins and the glyoxal resins, from the perspective of accelerating the reaction, use of a catalyst is preferred. The catalyst is not particularly limited so long as the catalyst is a conventional one, and examples of the catalyst include borofluoride compounds such as ammonium borofluoride and zinc borofluoride; neutral metal salt catalysts such as magnesium chloride and magnesium sulfate; and inorganic acids such as phosphoric acid, chloric acid and boric acid. On an as needed basis, an organic acid such as citric acid, tartaric acid, malic acid, maleic acid and lactic acid may be used as a co-catalyst in combination with the catalysts. Examples of the catalyst include CATALYST ACX, CATALYST 376, CATALYST 0, CATALYST M, CATALYST G(GT), CATALYST X-110, CATALYST GT-3, and CATALYST NFC-1 manufactured by DIC Corporation, UNIKA CATALYST 3-P and UNIKA CATALYST MC-109 manufactured by Union Chemical Industry Co., Ltd., and RIKEN FIXER RC series, RIKEN FIXER MX series and RIKEN FIXER RZ-5 manufactured by Mikiriken Industrial Co., Ltd.

As the compound having one or more isocyanate groups or blocked isocyanate groups, a monofunctional isocyanate compound such as butyl isocyanate, phenyl isocyanate, tolyl isocyanate and naphthalene isocyanate or a polyfunctional isocyanate compound may be used.

As the polyfunctional isocyanate compound, a conventionally known polyisocyanate compound may be used without particular limitation, so long as the compound has two or more isocyanate groups in a molecule. Examples of the polyfunctional compound include diisocyanate compounds such as alkylene diisocyanate, aryl diisocyanate, and cycloalkyl diisocyanate, and denatured polyisocyanate compounds such as dimers or trimers of the diisocyanate compounds. It is preferable that the carbon number of the alkylene diisocyanate be 1 to 12.

Examples of the diisocyanate compound include 2,4- or 2,6-tolylene diisocyanate, ethylene diisocyanate, propylene diisocyanate, 4,4-diphenylmethane diisocyanate, p-phenylene diisocyanate, tetramethylene diisocyanate, hexamethylene diisocyanate, decamethylene diisocyanate, dodecamethylene diisocyanate, 2,4,4-trimethyl hexamethylene-1,6-diisocyanate, phenylene diisocyanate, tolylene or naphthylene diisocyanate, 4,4′-methylene-bis(phenylisocyanate), 2,4′-methylene-bis(phenylisocyanate), 3,4′-methylene-bis(phenylisocyanate), 4,4′-ethylene-bis(phenylisocyanate), ω,ω′-diisocyanate-1,3-dimethylbenzene, ω,ω′-diisocyanate-1,4-dimethylcyclohexane, ω,ω′-diisocyanate-1,4-dimethylbenzene, ω,ω′-diisocyanate-1,3-dimethylcyclohexane, 1-methyl-2,4-diisocyanate cyclohexane,4,4′-methylene-bis(cyclohexylisocyanate),3-isocyanate-methyl-3,5,5-trimethyl cyclohexyl isocyanate, an acid-diisocyanate dimer, ω,ω′-diisocyanate diethylbenzene, ω,ω′-diisocyanate dimethyltoluene, ω,ω′-diisocyanate diethyltoluene, bis(2-isocyanate ethyl)fumarate ester, 1,4-bis(2-isocyanate-prop-2-yl)benzene, and 1,3-bis(2-isocyanate-prop-2-yl)benzene.

Examples of the triisocyanate compound include triphenylmethane triisocyanate, dimethyltriphenylmethane tetraisocyanate, and tris(isocyanate phenyl)-thiophosphate.

The denatured polyisocyanate compounds derived from diisocyanate compounds are not particularly limited so long as the compounds have two or more isocyanate groups, and examples thereof include polyisocyanates having a biuret structure, an isocyanurate structure, a urethane structure, a uretdione structure, an allophanate structure or a trimer structure, and adducts of aliphatic isocyanates of trimethylol propane. Also, polymeric MDI (MDI: diphenylmethane diisocyanate) may be used as a polyfunctional isocyanate compound.

One of the polyfunctional isocyanate compounds may be used singly, or two or more thereof may be used in combination.

The isocyanate group of the polyfunctional isocyanate compound may be as it is, or a blocked isocyanate group blocked with a blocking agent. Examples of the blocking agent include pyrazoles such as 3,5-dimethylpyrazole, 3-methylpyrazole, 3,5-dimethyl-4-nitropyrazole, 3,5-dimethyl-4-bromopyrazole, and pyrazole; phenols such as phenol, methylphenol, chlorophenol, iso-butylphenol, tert-butylphenol, iso-amylphenol, octylphenol and nonylphenol; lactams such as ε-caprolactam, δ-valerolactam and γ-butyrolactam; activated methylene compounds such as dimethyl malonate ester, diethyl malonate ester, acetyl acetone, methyl acetoacetate and ethyl acetoacetate; oximes such as formaldoxime, acetaldoxime, acetone oxime, methyl ethyl ketone oxime, cyclohexanone oxime, acetophenone oxime and benzophenone oxime; imidazole compounds such as imidazole and 2-methylimidazole; and sodium bisulfite. Among them, from the perspective of water repellency, pyrazoles and oximes are preferred.

As the polyfunctional isocyanate compound, water-dispersive isocyanates having a polyisocyanate structure with a hydrophilic group introduced to have surfactant effect for imparting water dispersibility to the polyisocyanate may be used as well. In order to accelerate the reaction, conventionally known catalysts such as organic tin and organic zinc may be used in combination.

One of the cross-linking agents and the catalysts may be used singly, or two or more thereof may be used in combination.

The cross-linking agent may be applied to an object to be treated (carpet), for example, by a method including a step of dipping the object to be treated in a liquid solution containing the cross-linking agent dissolved in an organic solvent or emulsion-dispersed in water and a step of drying the liquid solution adhered to the object to be treated. The cross-linking agent applied to the object to be treated is then heated, for the reaction between the cross-linking agent and the object to be treated and the non-fluorinated polymer (α) or the non-fluorinated polymer (β) to occur. In order to allow the reaction of the cross-linking agent to sufficiently improve the anti-soiling durability, it is preferable to heat from 110 to 180° C. for 1 to 5 minutes. The object to be treated can be simultaneously treated with the cross-linking agent and the treatment liquid containing the anti-soiling agent before being heated to ensure the adhesion of the cross-linking agent. When the steps are concurrently performed, for example, the liquid solution containing the anti-soiling agent and the cross-linking agent is applied to the object to be treated (carpet), and after removal of water, the cross-linking agent adheres to the object to be treated by further heating. In consideration of simplification of the anti-soiling process, reduction in heat, and economic efficiency, it is preferable to perform the steps of applying and heating the cross-linking agent simultaneously with the step of treating the carpet with the liquid solution containing the anti-soiling agent.

Use of an excessive amount of the cross-linking agent may cause deterioration of the texture. The amount of the cross-linking agent for use is preferably 0.1 to 50 mass %, particularly preferably 0.1 to 10 mass %, relative to the object to be treated (carpet).

The anti-soiling carpet in the present embodiment thus obtained can exhibit sufficient anti-soiling and water repellency properties even when it is used outdoors over a long period of time. Also, the anti-soiling carpet obtained by the manufacturing method in the present embodiment can be environment-friendly due to the use of non-fluorinated compounds.

The anti-soiling carpet obtained by the manufacturing method in the present embodiment may be applied with coating on a specified portion. Examples of the coating include moisture-permeable water-proof processing and wind-proof processing for sports use and outdoor use. For example, in the case of moisture-permeable water-proof processing, the processing can be performed by applying a coating liquid containing a urethane resin or an acrylic resin in a medium to the surface of an anti-soiling-processed carpet and drying the liquid.

Next, the anti-soiling carpet in an embodiment of the present invention is described.

At least a pile portion of the anti-soiling carpet in the present embodiment may comprise the non-fluorinated polymer (α) and the non-fluorinated polymer (β). Since the pile portion comprises the non-fluorinated polymer (α) and the non-fluorinated polymer (β), the anti-soiling carpet in the present embodiment can exhibit sufficient anti-soiling and water repellency properties even without having a fluorine compound with a fluoroalkyl group (for example, carbon-number: 4 to 8).

It is preferable that at least the pile portion of the anti-soiling carpet in the present embodiment comprise no fluorine compound with a fluoroalkyl group (for example, carbon number: 4 to 8).

From the perspective of water repellency, it is preferable that the pile portion of the anti-soiling carpet in the present embodiment further comprise the non-fluorinated polymer (γ).

It is preferable that the pile portion further comprise at least one of the non-fluorinated polymer (8) and the polyester resin (s).

The case where the pile portion comprises compounds such as the non-fluorinated polymer and the polyester resin may refer to an aspect where the surface of the fiber constituting the pile portion is coated with the compounds, or an aspect where the internal part of the fiber constituting the pile portion contains the compounds.

The anti-soiling carpet of the present embodiment may be obtained by the manufacturing method of the anti-soiling carpet in the present embodiment described above.

Although the preferred embodiments of the present invention have been described above, the present invention is not limited to the above embodiments. For example, although the polymerization reaction is performed through radical polymerization in the case of manufacturing the non-fluorinated polymers (a), (p), (γ), and (8) in the above embodiments, the polymerization reaction may be performed through photopolymerization with exposure to ionizing radiation such as ultraviolet rays, electron beams and γ-rays.

### EXAMPLES

The present invention is further described with reference to Examples as follows, though the present invention is not limited to Examples.

<Preparation of Non-Fluorinated Polymer Dispersion>

A mixture liquid having a composition shown in Table 1 (The numerical values in the table are expressed in mass (g).) was prepared and polymerized by the following procedure to obtain a non-fluorinated polymer dispersion.

### Synthesis Example 1

In a 500-mL pressure-resistant flask, 115 g of stearyl acrylate, 10 g of NK ester M-230G (product name, manufactured by Shin-Nakamura Chemical Co., Ltd., methoxypolyethylene glycol methacrylate), 12.5 g of ELEMINOL MON-7 (product name, manufactured by Sanyo Chemical Industries, Ltd., aqueous solution of 50 mass % dodecyl diphenyl ether sodium sulfonate), 5 g of SOFTANOL 120 (product name, manufactured by Nippon Shokubai Co., Ltd., polyoxyethylene alkyl ether, HLB=14.5), 41.5 g of tripropylene glycol, and 315.25 g of water were placed, and mixed and stirred at 50° C. to prepare a mixture liquid. The mixture liquid was exposed to ultrasonic waves, so that the entire monomers were emulsion-dispersed. Subsequently, 0.75 g of ammonium persulfate was added to the mixture liquid, and a radical polymerization was performed under nitrogen atmosphere at 70° C. for 6 hours, so that a non-fluorinated polymer dispersion containing 25 mass % of a non-fluorinated polymer was obtained.

### Synthesis Examples 2 to 14

Except that mixture liquids having compositions described in Table 1 or Table 2 were prepared, the polymerization was performed in the same manner as in Synthesis Example 1, so that non-fluorinated polymer dispersions containing 25 mass % of a non-fluorinated polymer each were obtained. Incidentally, the details of “LATEMUL PD-430” in the table are as follows.

LATEMUL PD-430: product name, manufactured by Kao Corporation, polyoxyalkylene alkenyl ether, HLB=14.4

### Synthesis Example 15

In a 500-mL pressure-resistant flask, 52.5 g of NK ester M-230G, 22.5 g of acrylonitrile and 315.25 g of water were placed, and mixed and stirred at 70° C. to prepare a mixture liquid. Subsequently, 0.375 g of 2,2′-azobis(2-aminedipropane)dihydrochloride was added to the mixture liquid, and a radical polymerization was performed under nitrogen atmosphere at 70° C. for 6 hours, so that a non-fluorinated polymer dispersion containing 15 mass % of a non-fluorinated polymer was obtained.

TABLE 1

| | Synthesis | Synthesis | Synthesis | Synthesis | Synthesis | Synthesis | Synthesis |
|---|---|---|---|---|---|---|---|
| | Example 1 | Example 2 | Example 3 | Example 4 | Example 5 | Example 6 | Example 7 |
| Stearyl acrylate | 115 | — | 115 | 110 | 110 | 90 | 90 |
| Stearyl methacrylate | — | 115 | — | — | — | — | — |
| Methyl methacrylate | — | — | — | — | — | 35 | 25 |
| Ethyl methacrylate | — | — | — | — | — | — | — |
| Isobornyl methacrylate | — | — | — | — | — | — | — |
| NK ester M-230 G | 10 | 10 | — | — | — | — | 10 |
| 2-hydroxyethyl acrylate | — | — | 10 | 10 | 10 | — | — |
| LATEMUL PD-430 | — | — | — | 5 | 5 | — | — |
| ELEMINOL MON-7 | 12.5 | 12.5 | 12.5 | 12.5 | — | 12.5 | 12.5 |
| SOFTANOL 120 | 5 | 5 | 5 | — | — | 5 | 5 |
| Stearyl amine trimethyl | — | — | — | — | 2 | — | — |
| ammonium chloride | | | | | | | |
| Water | 315.25 | 315.25 | 315.25 | 320.25 | 330.75 | 315.25 | 315.25 |
| Tripropylene glycol | 41.5 | 41.5 | 41.5 | 41.5 | 41.5 | 41.5 | 41.5 |
| Ammonium persulfate | 0.75 | 0.75 | 0.75 | 0.75 | 0.75 | 0.75 | 0.75 |

TABLE 2

| | Synthesis | Synthesis | Synthesis | Synthesis | Synthesis | Synthesis | Synthesis |
|---|---|---|---|---|---|---|---|
| | Example 8 | Example 9 | Example 10 | Example 11 | Example 12 | Example 13 | Example 14 |
| Stearyl acrylate | 105 | 45 | — | 25 | 5 | 25 | 45 |
| Stearyl methacrylate | — | 45 | 90 | — | — | — | — |
| Methyl methacrylate | — | 25 | 25 | 50 | 80 | — | — |
| Ethyl methacrylate | — | — | — | 30 | 30 | — | — |
| Isobornyl methacrylate | 10 | — | — | 20 | 10 | — | — |
| NK ester M-230 G | 10 | 10 | 10 | — | — | 100 | 80 |
| 2-hydroxyethyl acrylate | — | — | — | — | — | — | — |
| LATEMUL PD-430 | — | — | — | — | — | — | — |
| ELEMINOL MON-7 | 12.5 | 12.5 | 12.5 | 12.5 | 12.5 | 12.5 | 12.5 |
| SOFTANOL 120 | 5 | 5 | 5 | 5 | 5 | 5 | 5 |
| Stearyl amine trimethyl | — | — | — | — | — | — | — |
| ammonium chloride | | | | | | | |
| Water | 315.25 | 315.25 | 315.25 | 315.25 | 315.25 | 315.25 | 315.25 |
| Tripropylene glycol | 41.5 | 41.5 | 41.5 | 41.5 | 41.5 | 41.5 | 41.5 |
| Ammonium persulfate | 0.75 | 0.75 | 0.75 | 0.75 | 0.75 | 0.75 | 0.75 |

<Preparation of Hydrophilic Polyester Resin Dispersion>

In a 1000-mL pressure resistant flask having a Liebig condenser, 3.52 g of sodium dimethylsulfoisophthalate, 27.31 g of di(hydroxyethyl)terephthalate, 71.74 g of polyethylene glycol (molecular weight: 3000), and 7.43 g of ethylene glycol were placed to be mixed and dissolved at 130° C., to which 0.2 g of zinc acetate dihydrate was added. The temperature in the system was raised to 180° C., and 0.05 g of tetrabutoxy titanium was added thereto to be mixed. Subsequently, the temperature in the system was raised to 255° C., and the internal pressure in the reactor was reduced to 15 mmHg, so that a polycondensation reaction was performed while diol components were distillated from the reaction system. The distillate in the reaction had a weight of about 10 g. After the reaction for 6 hours, the inside of the reactor was returned to atmospheric pressure with nitrogen while lowering the temperature, and 40 g of diethylene glycol was added at 120° C. to be mixed. Further, 860 g of water was added to be mixed and stirred, so that a hydrophilic polyester resin dispersion containing 10 mass % of hydrophilic polyester resin was obtained.

<Preparation of Anti-Soiling Agent>

### Example 1

The non-fluorinated polymer dispersion in Synthesis Example 1 (aqueous solution containing 25 mass % of the non-fluorinated polymer (α)), SYCOAT EC-022 (manufactured by STI Polymer, Inc., copolymer of 19 mass % of butyl acylate and 81 mass % of methyl methacrylate, polymer Tg: 60° C.), (aqueous solution containing 50 mass % of non-fluorinated polymer (β)) and water were mixed, such that the anti-soiling agent was adjusted to have a non-fluorinated polymer dispersion concentration of 0.3% o.w.f., and a SYCOAT EC-022 concentration of 0.2% o.w.f.

### Examples 2 to 18, and Comparative Examples 1 to 5

Anti-soiling agents having compositions shown in Tables 3 to 6 each were prepared. In the tables, the details of “VYCAR 460X49”, “LAPONITE SL25”, “TECSEAL E-799/45” are as follows

VYCAR 460X49: product name, manufactured by The Lubrizol Corporation, polymer dispersion containing polymer of which monomer components comprising 70 mass % of vinyl chloride monomers.

LAPONITE SL25: product name, manufactured by BYK Additives & Instruments, dispersion containing 25 mass % of silicates.

TECSEAL E-799/45: product name, manufactured by Trub Emulsions Chemie, dispersion containing 45 mass % of ethylene-acrylate polymer.

TABLE 3

| | | Untreated | Example | Example | Example | Example | Example | Example |
|---|---|---|---|---|---|---|---|---|
| | | fabric | 1 | 2 | 3 | 4 | 5 | 6 |
| Non-fluorinated | Synthesis Example 1 | — | 0.3 | — | — | — | — | — |
| polymer (α) | Synthesis Example 2 | — | — | 0.3 | — | — | — | — |
| | Synthesis Example 3 | — | — | — | 0.3 | — | — | — |
| | Synthesis Example 4 | — | — | — | — | 0.3 | — | — |
| | Synthesis Example 5 | — | — | — | — | — | 0.3 | — |
| | Synthesis Example 6 | — | — | — | — | — | — | 0.3 |
| Non-fluorinated | Synthesis Example 11 | — | — | — | — | — | — | — |
| polymer (β) | Synthesis Example 12 | — | — | — | — | — | — | — |
| | Sycoat EC-022 | — | 0.2 | 0.2 | 0.2 | 0.2 | 0.2 | 0.2 |
| Non-fluorinated | Synthesis Example 13 | — | — | — | — | — | — | — |
| polymer (δ) | Synthesis Example 14 | — | — | — | — | — | — | — |
| | Synthesis Example 15 | — | — | — | — | — | — | — |
| Non-fluorinated | Vycar 460X49 | — | — | — | — | — | — | — |
| polymer (γ) | | | | | | | | |
| Polyester | Hydrophilic polyester | — | — | — | — | — | — | — |
| resin (ε) | resin dispersion | | | | | | | |
| Silicate dispersion | Laponite SL25 | — | — | — | — | — | — | — |
| Acrylic copolymer | TECSEAL E-799/45 | — | — | — | — | — | — | — |
| anti-soiling | ΔE | 12.3 | 8.6 | 8.9 | 9.1 | 9.3 | 9.3 | 9.6 |
| properties | | | | | | | | |
| Water repellency | Number of remaining | 5 | 0 | 0 | 0 | 0 | 0 | 0 |
| (water droplet method) | water droplets (pieces) | | | | | | | |
| Water repellency | Rating | B | A | A | A | A | A | A |
| (soaking method) | | | | | | | | |

TABLE 4

| | | Example | Example | Example | Example | Example | Example |
|---|---|---|---|---|---|---|---|
| | | 7 | 8 | 9 | 10 | 11 | 12 |
| Non-fluorinated | Synthesis Example 1 | — | — | — | — | 0.3 | 0.3 |
| polymer (α) | Synthesis Example 7 | 0.3 | — | — | — | — | — |
| | Synthesis Example 8 | — | 0.3 | — | — | — | — |
| | Synthesis Example 9 | — | — | 0.3 | — | — | — |
| | Synthesis Example 10 | — | — | — | 0.3 | — | — |
| Non-fluorinated | Synthesis Example 11 | — | — | — | — | 0.2 | — |
| polymer (β) | Synthesis Example 12 | — | — | — | — | — | 0.2 |
| | Sycoat EC-022 | 0.2 | 0.2 | 0.2 | 0.2 | — | — |
| Non-fluorinated | Synthesis Example 13 | — | — | — | — | — | — |
| polymer (δ) | Synthesis Example 14 | — | — | — | — | — | — |
| | Synthesis Example 15 | — | — | — | — | — | — |
| Non-fluorinated | Vycar 460X49 | — | — | — | — | — | — |
| polymer (γ) | | | | | | | |
| Polyester | Hydrophilic polyester | — | — | — | — | — | — |
| resin (ε) | resin dispersion | | | | | | |
| Silicate dispersion | Laponite SL25 | — | — | — | — | — | — |
| Acrylic copolymer | TECSEAL E-799/45 | — | — | — | — | — | — |
| anti-soiling properties | ΔE | 8.7 | 8.8 | 8.8 | 8.8 | 9.3 | 9.1 |
| Water repellency | Number of remaining | 1 | 0 | 1 | 1 | 0 | 0 |
| (water droplet method) | water droplets (pieces) | | | | | | |
| Water repellency | Rating | A | A | A | A | A | A |
| (soaking method) | | | | | | | |

TABLE 5

| | | Example | Example | Example | Example | Example | Example |
|---|---|---|---|---|---|---|---|
| | | 13 | 14 | 15 | 16 | 17 | 18 |
| Non-fluorinated | Synthesis Example 1 | 0.3 | — | — | — | — | — |
| polymer (α) | Synthesis Example 6 | — | 0.3 | 0.25 | 0.25 | 0.25 | 0.2 |
| Non-fluorinated | Synthesis Example 11 | — | — | — | — | — | — |
| polymer (β) | Synthesis Example 12 | — | — | — | — | — | — |
| | Sycoat EC-022 | 0.1 | 0.1 | 0.1 | 0.1 | 0.1 | 0.1 |
| Non-fluorinated | Synthesis Example 13 | — | — | 0.1 | — | — | — |
| polymer (δ) | Synthesis Example 14 | — | — | — | 0.1 | — | — |
| | Synthesis Example 15 | — | — | — | — | 0.1 | 0.185 |
| Non-fluorinated polymer (γ) | Vycar 460X49 | 0.1 | — | — | — | — | 0.015 |
| Polyester resin (ε) | Hydrophilic polyester | — | 0.1 | — | — | — | — |
| | resin dispersion | | | | | | |
| Silicate dispersion | Laponite SL25 | — | — | — | — | — | — |
| Acrylic copolymer | TECSEAL E-799/45 | — | — | — | — | — | — |
| Anti-soiling properties | ΔE | 8.9 | 8.8 | 8.7 | 8.8 | 8.8 | 8.5 |
| Water repellency | Number of remaining | 0 | 0 | 1 | 1 | 1 | 0 |
| (water droplet method) | water droplets (pieces) | | | | | | |
| Water repellency | Rating | A | A | A | A | A | A |
| (soaking method) | | | | | | | |

TABLE 6

| | | Comparative | Comparative | Comparative | Comparative | Comparative |
|---|---|---|---|---|---|---|
| | | Example 1 | Example 2 | Example 3 | Example 4 | Example 5 |
| Non-fluorinated | Synthesis Example 1 | 0.5 | — | — | — | — |
| polymer (α) | Synthesis Example 6 | — | 0.5 | — | — | — |
| Non-fluorinated | Synthesis Example 11 | — | — | — | 0.5 | — |
| polymer (β) | Synthesis Example 12 | — | — | — | — | — |
| | Sycoat EC-022 | — | — | 0.5 | — | — |
| Non-fluorinated | Synthesis Example 13 | — | — | — | — | — |
| polymer (δ) | Synthesis Example 14 | — | — | — | — | — |
| | Synthesis Example 15 | — | — | — | — | — |
| Non-fluorinated polymer (γ) | Vycar 460X49 | — | — | — | — | — |
| Polyester resin (ε) | Hydrophilic polyester | — | — | — | — | — |
| | resin dispersion | | | | | |
| Silicate dispersion | Laponite SL25 | — | — | — | — | 0.4 |
| Acrylic copolymer | TECSEAL E-799/45 | — | — | — | — | 0.1 |
| Anti-soiling properties | ΔE | 11.0 | 12.0 | 11.8 | 11.9 | 11.3 |
| Water repellency | Number of remaining | 4 | 0 | 5 | 5 | 5 |
| (water droplet method) | water droplets (pieces) | | | | | |
| Water repellency | Rating | A | A | B | B | B |
| (soaking method) | | | | | | |

<Manufacturing of Anti-Soiling Test Fabric>

As a test fabric, a loop pile carpet of polyester (1000 g/m²) was prepared. The anti-soiling agent in each of Examples and Comparative Examples was subjected to pH adjustment to have a pH of 1.5±0.1 with sulfamic acid, so that a liquid solution was obtained. The test fabric wetted with water was squeezed with a mangle to remove excess moisture (pick-up ratio: 70 mass %), and then impregnated with the liquid solution to have a specified concentration (% o.w.f.) described in Examples.

Subsequently, the test fabric was exposed to steam in a steamer (atmospheric pressure, 100±5° C., humidity: 100%) for 90 seconds. After the steam treatment, the excess test liquid was washed away with running water, and the moisture content was removed by a centrifugal dehydrator. The test fabric was then dried at 120° C. for 10 minutes and subjected to humidity conditioning at 20° C. and a humidity of 60% for a whole day and night.

The anti-soiling-processed test fabric thus manufactured was subjected to the evaluation on anti-soiling properties and water repellency by the following method.

<Evaluation on Anti-Soiling Properties>

By a method based on ASTM D6540-12, the surface of the anti-soiling-processed test fabric was soiled with a synthetic soil described in AATCC 122-2013, and then vacuumed by a cleaner to remove the synthetic soil, so that an anti-soiling-processed fabric after contamination was obtained. The L values, a values and b values of the anti-soiling-processed fabric were measured by SPECTROPHOTOMETER CM-3700d (manufactured by Konica Minolta Inc.) before and after contamination, and color difference ΔE in L*a*b* color system was calculated. AE can be obtained by the following equation, and the anti-soiling properties increase as the value decreases.

ΔE=((L₀−L_{S})²+(a₀−a_{S})²+(b₀−b_{S})²)^{1/2}

L₀: L value of anti-soiling-processed test fabric before contamination

L_{S}: L value of anti-soiling-processed test fabric after contamination

a₀: a value of anti-soiling-processed test fabric before contamination

a_{S}: a value of anti-soiling-processed test fabric after contamination

b₀: b value of anti-soiling-processed test fabric before contamination

b_{S}: b value of anti-soiling-processed test fabric after contamination

<Evaluation on Water Repellency>

(Water Droplet Method)

An aqueous solution containing 0.1 mg/L of FD&C Red (C. I. 16035) was adjusted to a pH of 2.8±0.1 with citric acid to prepare an aqueous solution of Red Dye. 1 droplet (5 mm diameter) of Red Dye Solution was placed on each of five spots on the surface of the anti-soiling-processed test fabric, and the test fabric was then tilted at an angle of 45°. After 10 seconds, the number of water droplets remained on or soaked into the test fabric was counted. The water repellency increases as the value decreases.

(Soaking Method)

In a flat stainless steel container filled with an aqueous Red Dye solution prepared in the same manner as described above, a 7-cm square anti-soiling-processed test fabric was placed on the surface of the aqueous Red Dye solution for 2 minutes. After the 2 minutes were over, excess aqueous solution of Red Dye was wiped off. In the case where the ratio of stained areas was 20% or less of the entire anti-soiling-processed test fabric, the evaluation was rated as “A”, and in the case where the ratio was more than 20%, the evaluation was rated as “B”.

What is claimed is:

1. A method of manufacturing an anti-soiling carpet comprising:
a step of treating a carpet with a liquid solution comprising an anti-soiling agent;
the anti-soiling agent containing a non-fluorinated polymer (α) and a non-fluorinated polymer (β);
the non-fluorinated polymer (α) containing a constituent unit derived from a monomer (A1) represented by formula (A-1) and a constituent unit derived from at least one monomer selected from the group consisting of a monomer (A2) represented by formula (A-2) and a monomer (A3) represented by formula (A-3), with a mixing ratio of the monomer (A1) of 60 mass % or more relative to the total amount of the monomer components constituting the non-fluorinated polymer (α);
the non-fluorinated polymer (β) containing a constituent unit derived from at least one monomer (A4) of methyl methacrylate and ethyl methacrylate and a constituent unit derived from a monomer (A5) represented by formula (A-5), with a mixing ratio of the monomer (A4) of 60 mass % or more relative to the total amount of the monomer components constituting the non-fluorinated polymer (β): 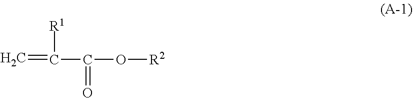
wherein R represents a hydrogen atom or a methyl group, and R² represents a monovalent hydrocarbon group having 12 to 30 carbon atoms, optionally having a substituent; 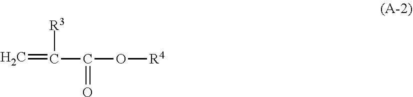
wherein R³ represents a hydrogen atom or a methyl group, and R⁴ represents a monovalent cyclic hydrocarbon group having 4 to 11 carbon atoms, optionally having a substituent, or a monovalent unsubstituted chain hydrocarbon group having 1 to 4 carbon atoms; 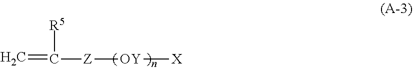
wherein R⁵ represents a hydrogen atom or a methyl group, X represents a hydroxyl group or a methoxy group, Y represents a linear or branched alkylene group having 2 to 4 carbon atoms, optionally having a hydroxyl group, Z represents a ketone group or a linear or branched alkylene group having 1 to 6 carbon atoms, n is an integer of 1 to 80, and in the case of n being 2 or more, the plurality of Y's may be the same or different from each other; 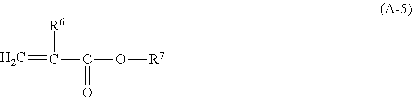
wherein R⁶ represents a hydrogen atom or a methyl group, and R⁷ represents a monovalent hydrocarbon group having 4 to 30 carbon atoms, optionally having a substituent.

2. The method according to claim 1, wherein the anti-soiling agent further contains a non-fluorinated polymer (γ),
the non-fluorinated polymer (γ) containing a constituent unit derived from at least one monomer (VC) of vinyl chloride and vinylidene chloride, with a mixing ratio of the monomer (VC) of 50 mass % or more relative to the total amount of the monomer components constituting the non-fluorinated polymer (γ).

3. The method according to claim 1, wherein the anti-soiling agent further contains at least one of a non-fluorinated polymer (δ) and a polyester resin (ε);
the non-fluorinated polymer (δ) containing a constituent unit derived from a monomer (A3) represented by formula (A-3), with a mixing ratio of the monomer (A3) of 60 mass % or more relative to the total amount of the monomer components constituting the non-fluorinated polymer (δ);
the polyester resin (ε) being a polyester resin represented by formula (B-1): 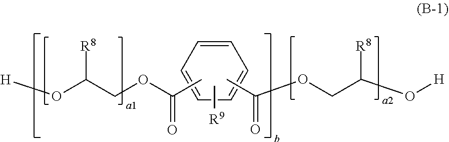
wherein R⁸ represents a hydrogen atom or a methyl group, R⁹ represents a hydrogen atom or a sodium sulfonate group, a1 and a2 each independently represent an integer of 1 to 200, b represents an integer of 1 to 20, the plurality of R⁸'s may be the same or different from each other, and in the case of b being 2 or more, the plurality of R⁹'s may be the same or different from each other.

4. The method according to claim 3, wherein the anti-soiling agent further contains a non-fluorinated polymer (γ), the non-fluorinated polymer (γ) containing a constituent unit derived from at least one monomer (VC) of vinyl chloride and vinylidene chloride, with a mixing ratio of the monomer (VC) of 50 mass % or more relative to the total amount of the monomer components constituting the non-fluorinated polymer (γ).

5. An anti-soiling carpet having at least a pile portion comprising:
a non-fluorinated polymer (α) and a non-fluorinated polymer (β),
the non-fluorinated polymer (α) containing a constituent unit derived from a monomer (A1) represented by formula (A-1) and a constituent unit derived from at least one monomer selected from the group consisting of a monomer (A2) represented by formula (A-2) and a monomer (A3) represented by formula (A-3), with a mixing ratio of the monomer (A1) of 60 mass % or more relative to the total amount of the monomer components constituting the non-fluorinated polymer (α),
the non-fluorinated polymer (β) containing a constituent unit derived from at least one monomer (A4) of methyl methacrylate and ethyl methacrylate and a constituent unit derived from a monomer (A5) represented by formula (A-5), with a mixing ratio of the monomer (A4) of 60 mass % or more relative to the total amount of the monomer components constituting the non-fluorinated polymer (β): 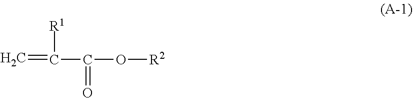
wherein R¹ represents a hydrogen atom or a methyl group, and R² represents a monovalent hydrocarbon group having 12 to 30 carbon atoms, optionally having a substituent; 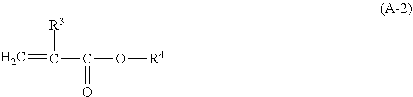
wherein R³ represents a hydrogen atom or a methyl group, and R⁴ represents a monovalent cyclic hydrocarbon group having 4 to 11 carbon atoms, optionally having a substituent, or a monovalent unsubstituted chain hydrocarbon group having 1 to 4 carbon atoms; 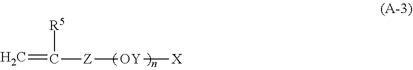
wherein R represents a hydrogen atom or a methyl group, X represents a hydroxyl group or a methoxy group, Y represents a linear or branched alkylene group having 2 to 4 carbon atoms, optionally having a hydroxyl group, Z represents a ketone group or a linear or branched alkylene group having 1 to 6 carbon atoms, n is an integer of 1 to 80, and in the case of n being 2 or more, the plurality of Y's may be the same or different from each other 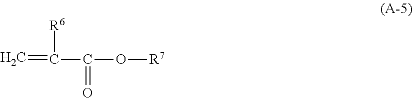
wherein R⁶ represents a hydrogen atom or a methyl group, and R⁷ represents a monovalent hydrocarbon group having 4 to 30 carbon atoms, optionally having a substituent.

6. The anti-soiling carpet-according to claim 5, wherein the pile part further comprises a non-fluorinated polymer (γ);
the non-fluorinated polymer (γ) containing a constituent unit derived from at least one monomer (VC) of vinyl chloride and vinylidene chloride, with a mixing ratio of the monomer (VC) of 50 mass % or more relative to the total amount of the monomer components constituting the non-fluorinated polymer (γ).

7. The anti-soiling carpet according to claim 5, wherein the pile part further comprises at least one of a non-fluorinated polymer (δ) and a polyester resin (ε);
the non-fluorinated polymer (δ) containing a constituent unit derived from a monomer (A3) represented by formula (A-3), with a mixing ratio of the monomer (A3) of 60 mass % or more relative to the total amount of the monomer components constituting the non-fluorinated polymer (δ);
the polyester resin (ε) being a polyester resin represented by formula (B-1): 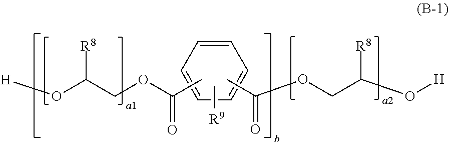
wherein R⁸ represents a hydrogen atom or a methyl group, R⁹ represents a hydrogen atom or a sodium sulfonate group, a1 and a2 each independently represent an integer of 1 to 200, b represents an integer of 1 to 20, the plurality of R⁸'s may be the same or different from each other, and in the case of b being 2 or more, the plurality of R⁹'s may be the same or different from each other.

8. The anti-soiling carpet according to claim 7, wherein the pile portion further comprises a non-fluorinated polymer (γ);
the non-fluorinated polymer (γ) containing a constituent unit derived from at least one monomer (VC) of vinyl chloride and vinylidene chloride, with a mixing ratio of the monomer (VC) of 50 mass % or more relative to the total amount of the monomer components constituting the non-fluorinated polymer (γ).
